(19) United States
(12) Patent Application Publication
(10) Pub. No.: US 2025/0064284 A1
(43) Pub. Date: Feb. 27, 2025

(54) Portable Vacuum With Removable Battery

(71) Applicant: The Noco Company, Glenwillow, OH (US)

(72) Inventors: Jonathan Lewis NOOK, Gates Mills, OH (US); James Richard STANFIELD, Glendale, AZ (US)

(21) Appl. No.: 18/809,434

(22) Filed: Aug. 20, 2024

Related U.S. Application Data
(60) Provisional application No. 63/578,472, filed on Aug. 24, 2023.

(51) Int. Cl. A47L 9/28; A47L 5/24; A47L 9/30; A47L 9/32; H01M 50/247; H01M 50/262; H02J 7/00; H02J 7/34

(52) U.S. Cl. CPC A47L 9/2884; A47L 5/24; A47L 9/2857; A47L 9/30; A47L 9/322; H01M 50/247; H01M 50/262; H02J 7/0048; H02J 7/342; H01M 2220/30; H02J 2207/30

(57) ABSTRACT

Systems and methods are provided for a portable vacuum comprising a vacuum portion including a suction end and a fan. A removable battery pack is removably attached to the vacuum portion and is configured to provide power to the fan during operation. The fun generates a suction force at the suction end. The removable battery pack comprises a plurality of charging ports including one or more first charging ports and one or more second charging ports. The first charging ports are configured to receive electrical current that charges the removable battery pack. The second charging ports are configured to charge one or more external electronic devices with power from the removable battery pack.

### CROSS-REFERENCE TO RELATED APPLICATIONS

This application claims priority to U.S. Provisional Application 63/578,472, filed Aug. 24, 2023, which is incorporated herein by reference in its entirety.

### FIELD

The present disclosure relates to vacuum cleaners, and in particular to portable electric vacuums.

### BACKGROUND

Portable vacuums are used to remove dust and debris from areas such as vehicles and houses. Some portable vacuums include rechargeable batteries that have limited functionality and are difficult or impossible to remove from the portable vacuum.

### SUMMARY

Systems and methods are provided for a portable vacuum comprising a vacuum portion including a suction end and a fan. A removable battery pack is removably attached to the vacuum portion and is configured to provide power to the fan during operation. The fan generates a suction force at the suction end. The removable battery pack comprises a plurality of charging ports including one or more first charging ports and one or more second charging ports. The first charging ports are configured to receive electrical current that charges the removable battery pack. The second charging ports are configured to charge one or more external electronic devices with power from the removable battery pack.

As another example, a portable vacuum comprises a vacuum portion including a suction end and a fan. A removable battery pack is removably attached to the vacuum portion and is configured to provide power to the fan during an operation of the portable vacuum. The fan generates a suction force at the suction end. The removable battery pack comprises a charging port that is configured to receive an electrical current and charge the removable battery pack with the electrical current. The charging port is further configured to charge an external electronic device with power from the removable battery pack.

As another example, a method of operating a portable vacuum includes charging a removable battery pack at a charging port of the removable battery pack. The method further includes attaching the removable battery pack to a vacuum portion of the portable vacuum. The method further includes powering the vacuum portion with the removable battery pack. The method further includes charging an external electronic device with the removable battery pack via the charging port.

### BRIEF DESCRIPTION OF THE DRAWINGS

FIG. 1 depicts a portable vacuum, in accordance with some embodiments.

FIG. 2 depicts a removable battery pack, in accordance with some embodiments.

FIG. 3 depicts a rear view of a removable battery pack, in accordance with some embodiments.

FIG. 4 depicts an isometric view of a portable vacuum, in accordance with some embodiments.

FIG. 5 depicts an isometric view of a removable battery pack, in accordance with some embodiments.

FIG. 6 depicts a front view of a portable vacuum, in accordance with some embodiments.

FIG. 7 depicts a rear view of a portable vacuum, in accordance with some embodiments.

FIG. 8 depicts a right side view of a portable vacuum, in accordance with some embodiments.

FIG. 9 depicts a left side view of a portable vacuum, in accordance with some embodiments.

FIG. 10 depicts a top view of a portable vacuum, in accordance with some embodiments.

FIG. 11 depicts a bottom view of a portable vacuum, in accordance with some embodiments.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. Also, descriptions of well-known functions and constructions may be omitted for increased clarity and conciseness.

It is to be understood that the phraseology and terminology employed herein are for the purpose of description and should not be regarded as limiting. For example, the use of a singular term, such as, “a” is not intended as limiting of the number of items. Also the use of relational terms, such as but not limited to, “top,” “bottom,” “left,” “right,” “upper,” “lower,” “down,” “up,” “side,” are used in the description for clarity and are not intended to limit the scope of the invention or the appended claims. Further, it should be understood that any one of the features can be used separately or in combination with other features. Other systems, methods, features, and advantages of the invention will be or become apparent to one with skill in the art upon examination of the detailed description. It is intended that all such additional systems, methods, features, and advantages be included within this description, be within the scope of the present invention, and be protected by the accompanying claims.

Portable vacuums provide convenience and portability to users when cleaning hard-to-reach areas (e.g., corners and crevices) or areas distant from electrical outlets. Some portable vacuums include rechargeable batteries that cannot be easily removed from the portable vacuum. In such examples, the entire portable vacuum must be moved to a charging location (e.g., connected to a charging chord at an electrical outlet) to charge the rechargeable batteries. Moreover, in some examples the rechargeable batteries are only capable of charging the portable vacuum.

Systems and methods disclosed herein include a portable vacuum with a removable battery pack that can be independently charged when not connected to the portable vacuum. Moreover, the removable battery pack may be configured to power external electronic devices such as cell phones or laptops. Systems and methods disclosed herein may result in increased functionality and portability, as well as more efficient uses of stored power within a portable vacuum.

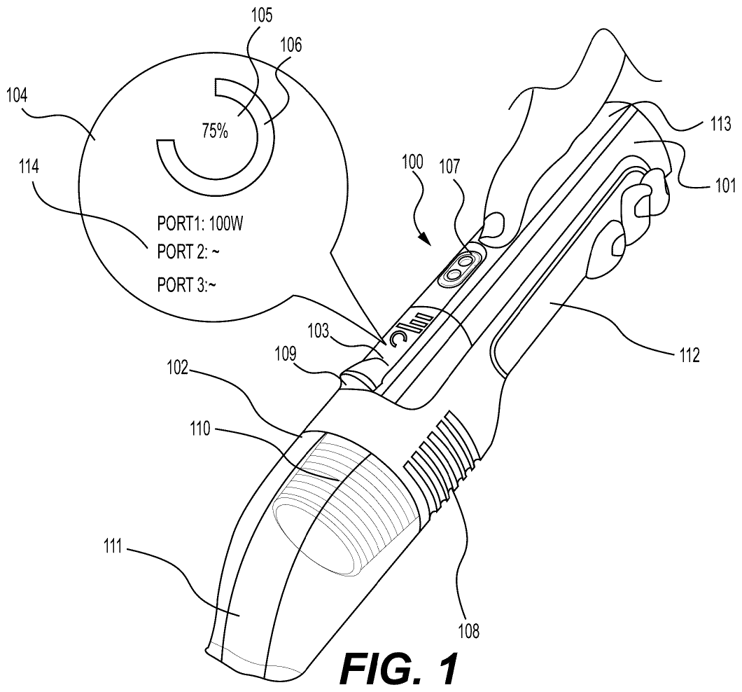

FIG. 1 depicts a portable vacuum, in accordance with some embodiments. In the example embodiment depicted in FIG. 1, the portable vacuum 100 includes a vacuum portion 102 and a removable battery pack 101. The removable battery pack 101 may be removably attached to the vacuum portion 102. The removable battery pack 101 may be configured to provide power to the portable vacuum 100 when it is attached to the vacuum portion 102. The removable battery pack 101 may also be configured to provide power to external electronic devices (e.g., cell phones, laptops, smart watches) when it is disconnected from the vacuum portion 102, as described further below. In embodiments, the removeable battery pack 101 may function as the handle for the portable vacuum, as shown in FIG. 1. In other embodiments, however, the removeable battery pack may be removably attached to or within the handle of the portable vacuum.

The removable battery pack 101 may include a top portion 113 that includes a display screen 103. FIG. 1 includes an enlarged view 104 of the display screen 103. The display screen 103 may indicate, for example, a charging level of the removable battery pack 101. The display screen may include a visual indicator 106 and numeric indicator 105 depicting the charging level of the removable battery pack 101. In the example shown in FIG. 1, the display screen 103 includes a numeric indicator 105 showing the percentage of a full charge the removable battery pack 101 has remaining. In addition, the display screen 103 may include a visual indicator 106 depicting the percentage of the full charge the removable battery pack 101 has remaining. For example, the visual indicator 106 may be a portion of a circumference of a circle that is proportional to the remaining battery percentage.

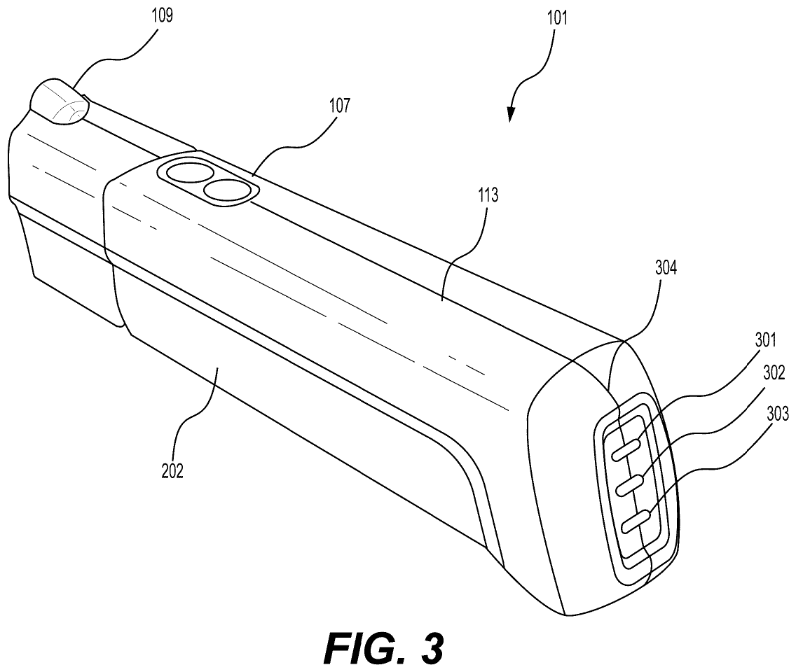

The display screen 103 may also include one or more charging indicators 114 showing the operation of one or more charging ports (shown in FIG. 3). The charging ports are described further in the description of FIG. 3. In the example shown in FIG. 1, the display screen 103 includes a charging indicator for a first charging port 301, a charging indicator for a second charging port 302, and a charging indicator for a third charging port 303. As shown in FIG. 1, the charging indicator for the first charging port 301 is operating at 100 Watts, while the indicators for the second and third charging ports 302, 303 show that the remaining charging ports 302, 303 are disconnected or are neither charging the portable vacuum 100 nor discharging from the portable vacuum 100. In addition to showing the power (e.g., wattage) of the charging ports, the display screen 103 may be further configured to show the current or voltage at which the charging ports are operating. The display screen 103 may also be configured to show whether the respective charging ports are being used to charge the removable battery pack 101 or to charge an external device (e.g., a laptop or cellphone) from the removable battery pack 101. Based on the charging parameters (e.g., wattage, current, voltage) and charging direction, the display screen 103 can show a user how quickly a connected device is being charged by the removable battery back 101 or how quickly the removable battery pack 101 is being charged. The display screen 103 can also show the potential number of charge cycles of each charging port based on the charging parameters. In addition, the display screen 103 may provide other information about a connected electronic device or the removable battery pack 101, such as capacitance, resistance, and temperature.

The removable battery pack 101 may further include a flashlight 109. In the example depicted in FIG. 1, the flashlight 109 is coupled to the top portion 113 of the removable battery pack 101. The flashlight 109 may include, for example, one or more light-emitting diodes (LEDs). When the removable battery pack 101 is disconnected from the vacuum portion 102, the flashlight 109 can act as a light source for a user of the removable battery pack 101. When the removable battery pack 101 is connected to the vacuum portion 102, the flashlight 109 can provide light for a user of the portable vacuum 100 when the portable vacuum 100 senses low light conditions. For example, the removable battery 101 pack may include a light sensor (not shown) to measure a light level of the area surrounding the portable vacuum 100. The flashlight 109 may turn on when the portable vacuum 100 is in use (e.g., turned on) and the light level of the surrounding area is below a predetermined level. Additionally or alternatively, the flashlight 109 may turn on when it is manually turned on by the user of the portable vacuum 100. In some embodiments, the removable battery pack 101 does not include a flashlight 109.

The top portion 113 of the removable battery pack 101 may further include one or more buttons 107. The buttons 107 may include, for example, a power button to power on and off the portable vacuum 100, and a flashlight button to power on and off the flashlight 109. The flashlight button may also be configured to increase the brightness of the flashlight 109 by discrete amounts from zero brightness (e.g., “off”) to full brightness based on successive presses of the flashlight button. The buttons 107 may further include a bidirectional charging button to enable or disable an ability of the removable battery pack 101 to charge external electronic devices. The bidirectional charging button may be used, for example, when the removable battery pack 101 is connected to the vacuum portion 102 to enable simultaneous operation of the portable vacuum 100 and the charging of the external electronic devices.

The vacuum portion 102 may include a suction end 111 having an opening for receiving dust and debris during operation of the portable vacuum 100. A filter 110 may be located on the interior of the vacuum portion 102 and may collect dirt and other particles and prevent them from being expelled back into the air. The suction end 111 may be removable such that the filter 110 can be accessed for removal or replacement. The vacuum portion 102 may include a fan (not shown) on the interior of the vacuum portion 102 that is configured to generate a suction force at the suction end 111 during operation of the portable vacuum 100. The vacuum portion 102 may also include one or more vents 108 to facilitate air flow during operation of the portable vacuum 100.

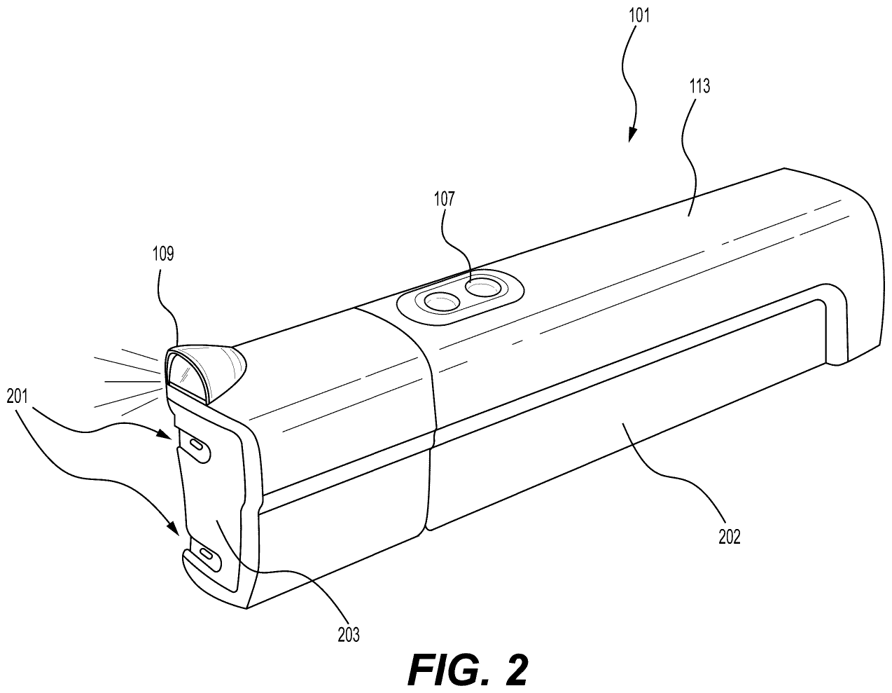

The vacuum portion 102 may also include a smooth handle 112 for the user to grip when operating the portable vacuum 100. The handle 112 may accommodate a lower portion of the removable battery pack 101 during operation of the portable vacuum 100. Moreover, the handle may be configured to receive the removable battery pack 101 via a connection mechanism (e.g., snap-fit connection or clips) to securely hold the removable battery pack 101 to the vacuum portion 102 during operation, as described below with reference to FIG. 2. In some example embodiments, the handle 112 includes a gripping surface for the user of the portable vacuum 100 to grip the handle 112 when using the portable vacuum 100. The gripping surface may be made of a soft material (e.g., rubber) and may include a plurality of protrusions (e.g., bumps) to facilitate the gripping of the vacuum portion 102.

FIG. 2 depicts a removable battery pack, in accordance with some embodiments. In the example embodiment shown in FIG. 2, the removable battery pack 101 includes a front surface 203 that includes one or more clips 201 for attaching the removable battery pack 101 from the vacuum portion 102. The vacuum portion 102 may also include one or more corresponding fasteners for securing the removable battery pack 101 to the vacuum portion 102 at the one or more clips 201 of the removable battery pack 101. The removable battery pack 101 may be detachable from the vacuum portion 102 at the clips 201 when a predetermined level of force is applied to remove the removable battery pack 101. In some examples, the user may be required to press a button 107 to disengage the removable battery pack 101 from the vacuum portion 102. The removable battery pack 101 may also include an indented portion 202 that rests within the handle 112 of the vacuum portion 102, such that the remaining surface of the removable battery pack 101 is substantially flush with the handle 112 of the vacuum portion 102.

FIG. 3 depicts a rear view of a removable battery pack, in accordance with some embodiments. In the example shown in FIG. 3, the removable battery pack 101 includes a rear surface 304 that includes one or more charging ports 301, 302, 303. The charging ports 301, 302, 303 may, for example, include one or more types of USB connections, such as USB-C ports. The charging ports 301, 302, 303 may also be located on other portions or sides (e.g., the top surface 113) of the removable battery pack 101. The charging ports 301, 302, 303 may be used to charge the removable battery pack 101. The charging ports 301, 302, 303 may also be used to charge external electronic devices, such as cell phones or laptops. The removable battery pack 101 can be charged at a variety of locations, including when it is attached to the vacuum portion 102.

The removable battery pack 101 can also be used as an independent power station for charging multiple devices, including phones, tablets, laptops, and other electronic devices. For example, one or more of the charging ports 301, 302, 303 may be an input/output (I/O) port. The removable battery 101 pack may utilize the I/O port to act as a standalone power source to power an external electronic device when the removable battery pack 101 is detached from the vacuum portion 102. In some example embodiments, the charging ports 301, 302, 303 can be used to power external devices while the removable battery pack 101 is attached to and powering the vacuum portion 102. The removable battery pack 101 can also utilize pass-through technology to allow a depleted removable battery pack 101 to be connected to a charging cable (e.g., a USB standard cable such as a USB-C cable) to recharge the removable battery pack 101 and power the portable vacuum 100 at the same time. Moreover, one or more of the charging ports 301, 302, 303 may be utilized to charge the removable battery pack 101, while simultaneously one or more other charging ports 301, 302, 303 are utilized to provide external power to one or more electronic devices.

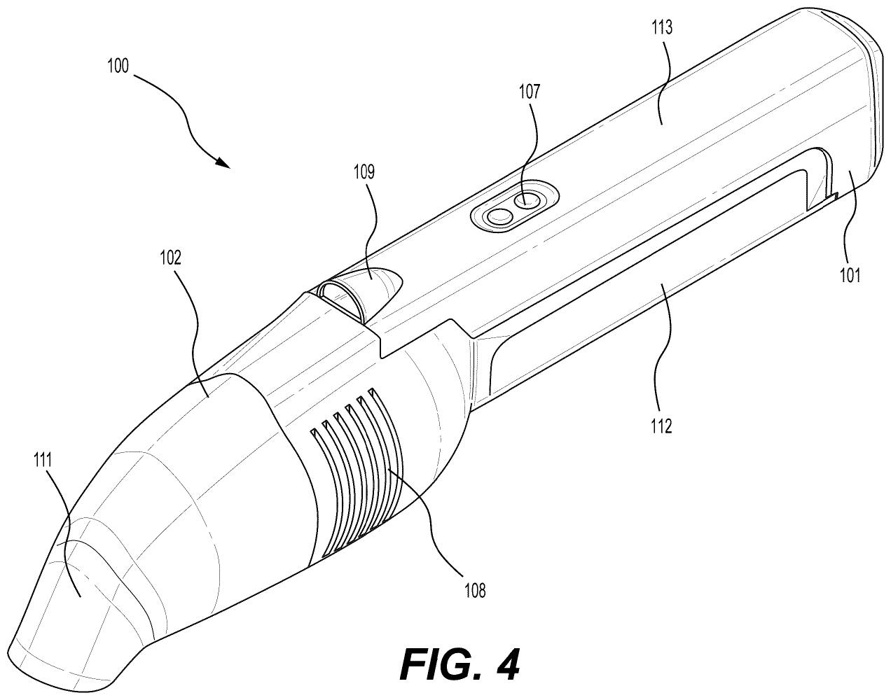

FIG. 4 depicts an isometric view of a portable vacuum, in accordance with some embodiments. As shown in FIG. 4, the flashlight 109 may extend above the vacuum portion 102 to illuminate the area being cleaned.

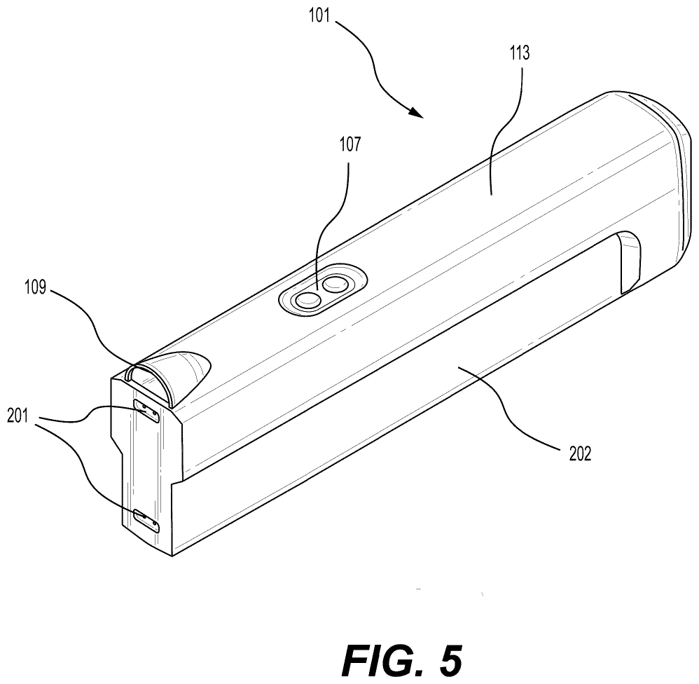

FIG. 5 depicts an isometric view of a removable battery pack, in accordance with some embodiments. In the example shown in FIG. 5, the removable battery pack 101 includes two clips 201 at each of two different locations on the front surface of the removable battery pack 101 for attachment to the vacuum portion 102.

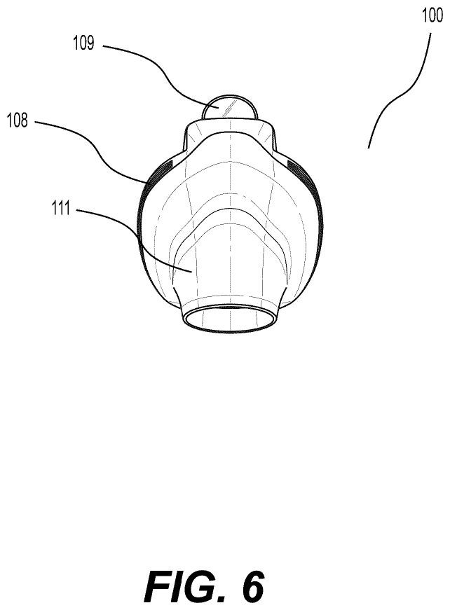

FIG. 6 depicts a front view of a portable vacuum, in accordance with some embodiments. As shown in FIG. 6, the suction end 111 may extend downward from the rest of the vacuum portion 102 and may narrow to facilitate easier access to corners and crevices.

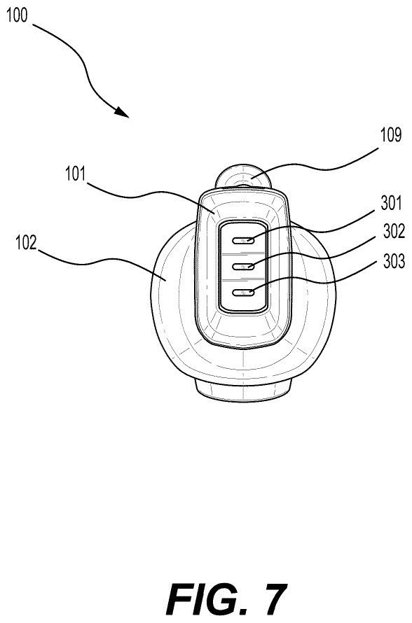

FIG. 7 depicts a rear view of a portable vacuum, in accordance with some embodiments.

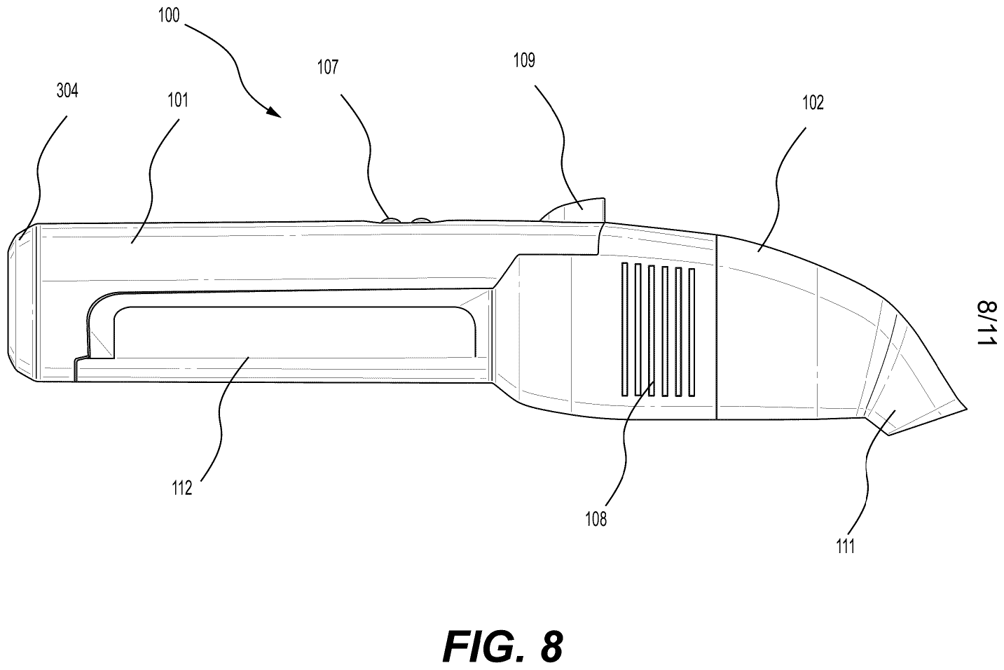

FIG. 8 depicts a right side view of a portable vacuum, in accordance with some embodiments.

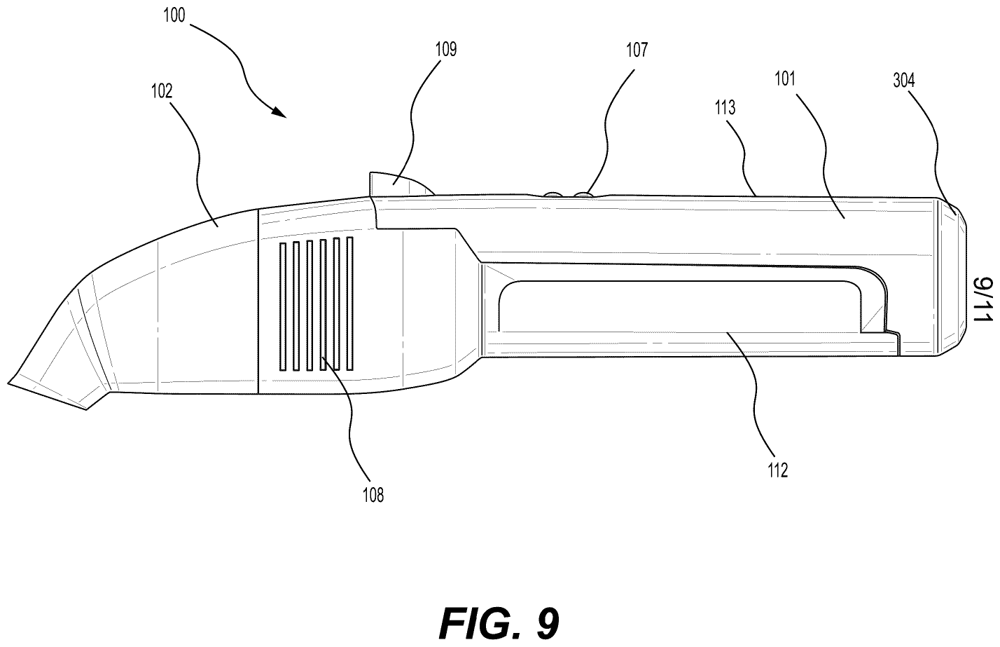

FIG. 9 depicts a left side view of a portable vacuum, in accordance with some embodiments.

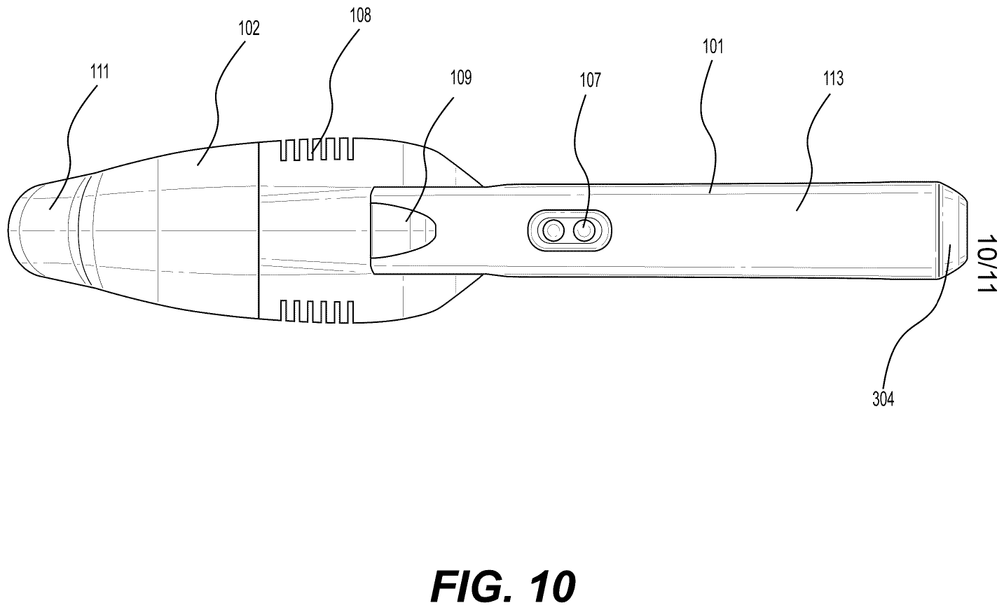

FIG. 10 depicts a top view of a portable vacuum, in accordance with some embodiments.

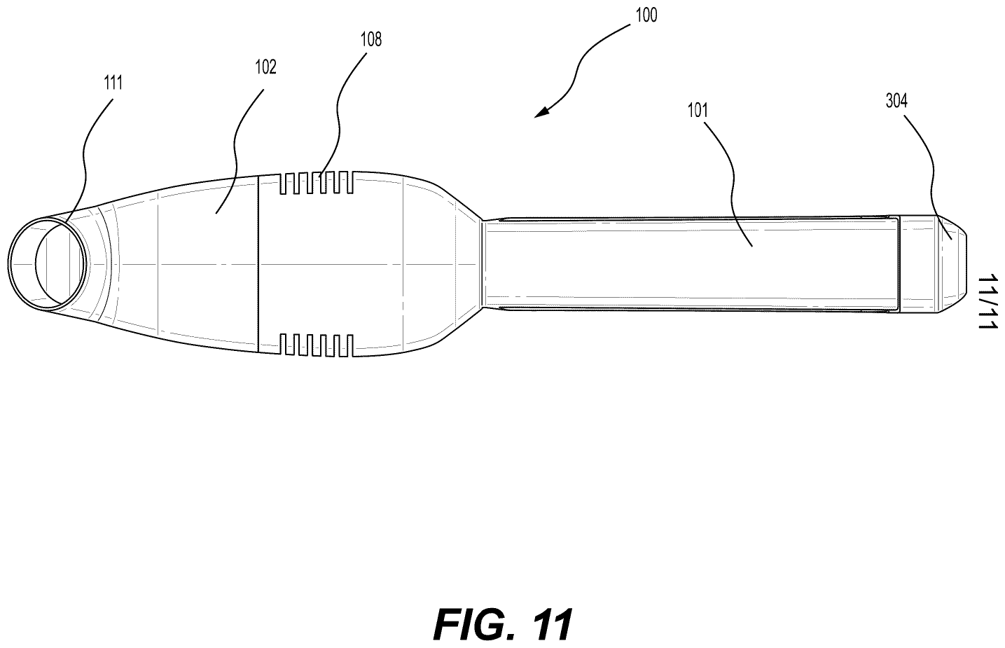

FIG. 11 depicts a bottom view of a portable vacuum, in accordance with some embodiments. As shown in FIG. 11, the vents 108 may extend from the sides of the vacuum portion 102 to an underside of the vacuum portion 102. Furthermore, the opening at the suction end 111 may be substantially circular. In some example embodiments, the opening at the suction end 111 may be rectangular or another shape.

It will be appreciated by those skilled in the art that changes could be made to the embodiments described above without departing from the broad inventive concept thereof. It is understood, therefore, that the invention disclosed herein is not limited to the particular embodiments disclosed, and is intended to cover modifications within the spirit and scope of the present invention.

What is claimed is:

1. A portable vacuum comprising:
a vacuum portion including a suction end and a fan;
a removable battery pack removably attached to the vacuum portion, the removable battery pack configured to provide power to the fan during an operation of the portable vacuum, the fan generating a suction force at the suction end, the removable battery pack comprising a plurality of charging ports, the plurality of charging ports including:
one or more first charging ports configured to receive electrical current, the electrical current charging the removable batter pack; and
one or more second charging ports configured to charge one or more external electronic devices with power from the removable battery pack.

2. The portable vacuum of claim 1, further comprising a display screen configured to display a charging level of the removable battery.

3. The portable vacuum of claim 1, wherein the removable battery pack further comprises a flashlight, a first button configured to power the flashlight, and a second button configured to power the vacuum portion when the removable battery pack is attached to the vacuum portion.

4. The portable vacuum of claim 1, wherein the plurality of charging ports are USB-C charging ports.

5. The portable vacuum of claim 1, wherein the one or more first charging ports are further configured to charge one or more external electronic devices with power from the removable battery pack, wherein the one or more second charging ports are further configured to receive electrical current, the electrical current charging the removable battery pack.

6. The portable vacuum of claim 5, wherein the display screen is further configured to display an indicator indicating whether the plurality of charging ports are operating in an input mode or an output mode.

7. The portable vacuum of claim 1, wherein the display screen is further configured to display a charging parameter of the charging port.

8. The portable vacuum of claim 1, wherein the charging level includes a visual and a numeric indicator.

9. The portable vacuum of claim 1, wherein the removeable battery pack functions as a handle for the portable vacuum.

10. The portable vacuum of claim 1, further comprising a clip, the clip configured to attach the removable battery pack to the vacuum portion.

11. The portable vacuum of claim 1, wherein the one or more first charging ports and the one or more second charging ports are configured to operate simultaneously.

12. The portable vacuum of claim 1, further comprising a bidirectional charging button, the bidirectional charging button configured to enable or disable the charging of the one or more external electronic devices with the power from the removable battery pack.

13. A portable vacuum comprising:
a vacuum portion including a suction end and a fan;
a removable battery pack removably attached to the vacuum portion, the removable battery pack configured to provide power to the fan during an operation of the portable vacuum, the fan generating a suction force at the suction end, the removable battery pack comprising a charging port, the charging port configured to receive an electrical current and charge the removable battery pack with the electrical current, the charging port further configured to charge an external electronic device with power from the removable battery pack.

14. The portable vacuum of claim 13, further comprising a display screen configured to display a charging level of the removable battery.

15. The portable vacuum of claim 13, wherein the charging port is a USB-C charging port.

16. The portable vacuum of claim 13, wherein the display screen is further configured to display an indicator indicating whether the charging port is being used to charge the removable battery or to charge an external electronic device.

17. The portable vacuum of claim 13, further comprising a plurality of additional charging ports, each of the additional charging ports configured to receive an electrical current and charge the removable battery pack with the electrical current, the additional charging ports further configured to charge an external electronic device with power from the removable battery pack.

18. A method of operating a portable vacuum including:
charging a removable battery pack at a charging port of the removable battery pack;
attaching the removable battery pack to a vacuum portion of the portable vacuum;
powering the vacuum portion with the removable battery pack; and
charging an external electronic device with the removable battery pack via the charging port.

19. The method of claim 18, further comprising removing the removable battery pack from the vacuum portion.

20. The method of claim 18, further comprising displaying a charging level of the removable battery pack on a display screen.
